(19) United States
(12) Patent Application Publication
(10) Pub. No.: US 2026/0078030 A1
(43) Pub. Date: Mar. 19, 2026

(54) SYSTEM AND METHOD FOR PFAS-CONTAMINATED WATER TREATMENT

(71) Applicant: LACKS ENTERPRISES, INC., Grand Rapids, MI (US)

(72) Inventors: Robert BIERI, Grand Rapids, MI (US); Michael LAVALLEE, Grand Rapids, MI (US); Alan FANTA, Grand Rapids, MI (US)

(73) Assignee: LACKS ENTERPRISES, INC., Grand Rapids, MI (US)

(21) Appl. No.: 19/330,945

(22) Filed: Sep. 17, 2025

Related U.S. Application Data
(60) Provisional application No. 63/695,610, filed on Sep. 17, 2024.

(51) Int. Cl. C02F 1/58; C02F 1/44; C02F 101/32

(52) U.S. Cl. CPC C02F 1/583; C02F 1/442; C02F 2101/327; C02F 2201/007; C02F 2201/008; C02F 2201/009

(57) ABSTRACT

A system for treating water containing pre- and poly-fluoroalkyl substances (PFAS) includes a PFAS concentration system having at least one foam concentration unit to generate a PFAS solution, at least one holding tank storing the PFAS solution, and a PFAS destruction system arranged on a mobile platform. The mobile PFAS destruction system is selectively positioned to destroy the PFAS solution. Further, the mobile PFAS destruction system includes a PFAS destruction unit connected to and in fluid communication with the at least one holding tank, and stationed at each site having at least one holding tank to destroy the PFAS solution.

### CROSS-REFERENCE TO RELATED APPLICATIONS

This application claims priority to and the benefit of U.S. Provisional Patent Application No. 63/695,610, filed Sep. 17, 2024, the content of which is incorporated herein by reference in its entirety.

### FIELD

The present disclosure generally relates to a system and method to treat per- and polyfluoroalkyl substances (PFAS) from water and particularly relates to a mobile system and method to remove and destroy the PFAS from water.

### BACKGROUND

The statements in this section merely provide background information related to the present disclosure and may not constitute prior art.

There is increased concern among the public and regulatory agencies regarding the presence of per- and polyfluoroalkyl substance (PFAS) in ground water. This class of chemicals has been identified as having deleterious effects on human and animal health. The effect of the chemicals on the body is exacerbated due their ability to bioaccumulate. Furthermore, the chemicals have extremely long half lives in the environment and do not breakdown readily under normal conditions. Hence, they have acquired the moniker of “forever chemicals”.

These chemicals are man-made and are used in a number of industries. They have been incorporated into a large number of products over the years and, as these products have degraded, the PFAS chemicals have been released into the environment contaminating water sources all over the world. Furthermore, these chemicals are used in a number of industrial processes where PFAS chemicals are present in the waste effluent of factories.

Regulatory agencies have been assessing the scope of the issue and determined that acceptable levels of PFAS emissions are in the single digit part per trillion levels. This has created the need for treatment methods for water emission at plant sites using PFAS chemicals in their processes, but also for treating ground water and other open water sites that have unacceptable levels of PFAS contamination. Treating captured PFAS at the collection site and destroying it at the site is preferred since the transportation of contaminated PFAS streams must be handled as a toxic substance requiring a higher level of care, documentation, and transport.

### SUMMARY

The present disclosure provides a mobile per- and poly-fluoroalkyl substances (PFAS) treatment system that collects PFAS from contaminated water, generates PFAS solutions having bubbles or foam, and destroys the PFAS solutions. Further, other technologies for capturing PFAS from water include passing intake water through columns containing granular activated carbon (GAC) or in combination with ion exchange resins. According to an exemplary form of the present disclosure, the method of treating water containing the PFAS includes the step of receiving water containing the PFAS in a PFAS concentration system, generating a PFAS solution by the PFAS concentration system, storing the PFAS solution in at least one holding tank, arranging a PFAS destruction system on a mobile platform, and connecting selectively the mobile PFAS destruction system to the at least one holding tank and destroying the PFAS solution.

According to a further aspect of the present disclosure, the step of selectively connecting the mobile PFAS destruction system includes the step of selectively stationing the destruction system at multiple sites having the at least one holding tank to destroy the PFAS solution at each of the multiple sites.

According to a further aspect of the present disclosure, the step of selectively connecting the mobile PFAS destruction system includes the step of connecting at least one PFAS destruction unit of the mobile PFAS destruction system to the at least one holding tank in a fluid communication. The PFAS destruction unit is connected to and in fluid communication with the PFAS concentration system such that a treated PFAS solution is fed back to the PFAS concentration system for further treatment. The mobile PFAS destruction system further includes a power source configured to operate the PFAS destruction unit.

According to a further aspect of the present disclosure, the step of receiving the water containing the PFAS includes the step of feeding the water into a nano-prefiltration unit in the PFAS concentration system.

According to a further aspect of the present disclosure, the PFAS concentration system is arranged on a mobile platform. The PFAS concentration system includes at least one PFAS concentration unit having a foam fractionation unit. The step of generating the PFAS solution may include the step of creating bubbles or foam by the foam fractionation unit of the at least one PFAS concentration unit.

According to a further aspect of the present disclosure, the at least one holding tank is placed in a contaminated site or in the PFAS concentration system such that as an exemplary embodiment of the present disclosure, the at least one holding tank is connected to and in fluid communication with a foam fractionation unit of the PFAS concentration system to accumulate the PFAS solution.

According to another aspect of the present disclosure, a system for treating water containing pre- and poly-fluoroalkyl substances (PFAS) includes a PFAS concentration system including at least one foam concentration unit to generate a PFAS solution, at least one holding tank storing the PFAS solution, and a PFAS destruction system arranged on a mobile platform. Further, the mobile PFAS destruction system is selectively connected to the at least one holding tank to destroy the PFAS solution.

According to a further aspect of the present disclosure, the mobile PFAS destruction system includes a PFAS destruction unit connected to and in fluid communication with the at least one holding tank. The mobile PFAS destruction system is stationed at each site having at least one holding tank to destroy the PFAS solution from the at least one holding tank at each of the multiple sites.

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a schematic view of a water treatment system for treating water containing PFAS in accordance with an exemplary embodiment of the present disclosure;

FIG. 2A is a PFAS concentration system arranged on a mobile platform in accordance with an exemplary embodiment of the present disclosure;

FIG. 2B is a PFAS destruction system arranged on a mobile platform in accordance with an exemplary embodiment of the present disclosure; and

FIG. 3 is a diagram showing a mobile PFAS destruction system used to treat three contaminated sites in accordance with an exemplary embodiment of the present disclosure.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the drawings, corresponding reference numerals indicate like or corresponding parts and features.

Typical technologies for capturing PFAS from water streams include passing intake water streams through columns containing granular activated carbon (GAC) or in combination with ion exchange resins. Other technologies include foam fractionation methods which use various methods for creating foam, some of which can control the size of the bubbles in the foam that is generated.

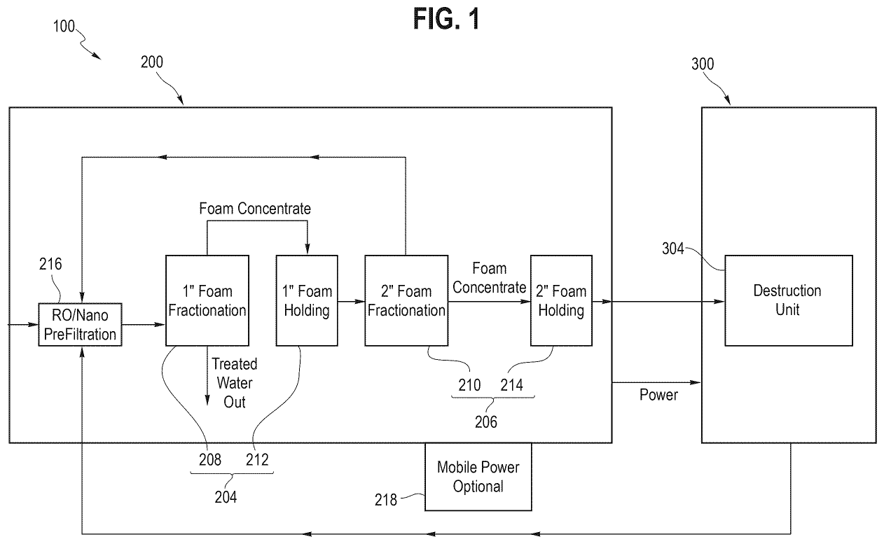

In accordance with an embodiment of the present disclosure, FIG. 1 shows a PFAS treatment system 100 including a mobile PFAS concentration system 200 and a mobile PFAS destruction system 300. As shown in an exemplary embodiment of FIG. 1, the mobile PFAS concentration system 200 is operated by a foam fractionation method, which is relatively simple to operate because it has few moving parts other than pumps to move the solutions. The method relies on the fact that PFAS chemicals tend to concentrate at air/liquid interfaces. Creating a foam generates a large surface area of such interfaces, so collecting the foam will naturally have an increased concentration of PFAS compared to the solution left behind. By performing sequential foaming, in other words breaking foam that is collected to a liquid and reforming the foam/liquid solution, it is possible to further concentrate the PFAS chemicals after passing through multiple foaming operations.

It will also be understood that the system may operate according a variety of other methods. The mobile PFAS concentration system may have other methods for capturing PFAS from the contaminated water. For example, the methods of the system include a plurality of vessels including granular activated carbon (GAC) or ion exchange resin. At least one vessel may comprise granular activated carbon (GAC), or at least one vessel may comprise ion exchange resin to concentrate PFAS solutions. Further, at least a first vessel may comprise granular activated carbon (GAC) and at least a second vessel may comprise ion exchange resin. The first and second vessels may be arranged in series or in parallel to concentrate the PFAS solutions in the mobile PFAS concentration system.

In the present disclosure, in FIG. 1, the foam fractionation systems don't have active absorbents that wear down over time and need to be replaced. Furthermore, the prior systems having a plurality of vessels including granular activated carbon (GAC) or ion exchange resin have to be periodically flushed when the active sites are full of PFAS and other chemicals that absorb to the media to be collected as a concentrated stream, which means the prior system is offline during this process. In general, the system and method of the present disclosure works by taking contaminated water streams and passing them through the concentration system. Treated water is returned to the source and the concentrated PFAS solution is stored in a holding tank.

In general, various technologies have been developed and disclosed for destroying PFAS chemicals including electrochemical oxidation, super critical waster oxidation (SCWO), and thermal combustion just to name a few. These destruction units are typically parts of larger systems that are dedicated to a PFAS, usually at a factory production site. Other destruction systems have been developed as stand-alone facilities that can be used to consume PFAS solutions that are brought to that site. In some respects, it may be cost effective to build a large PFAS destruction facility that is capable of receiving PFAS solutions from various sites. However, there are hurdles to overcome in shipping PFAS laden solutions, even at very low concentrations. These solutions are considered hazardous waste and must be treated accordingly, necessitating extensive documentation and labelling requirements. There are also DOT transportation requirements due to this designation as well.

Referring back to FIG. 1 of the present disclosure, the PFAS treatment system 100 comprises the mobile PFAS destruction system 300, which is capable of destroying PFAS in aqueous solutions and further is used in tandem with the mobile PFAS concentration system 200. In order to avoid the need to transport the liquid and take on the regulatory burden associated with the PFAS laden solutions, as shown in an exemplary embodiment of FIG. 1, the PFAS treatment system 100 includes the mobile PFAS destruction system 300, which is capable of treating (i.e., destroying) the concentrated PFAS solution at the concentration site, in which the PFAS solutions are stored. The mobile destruction system 300 may be modular relative to the concentration system 200, and can be moved to different locations and used connected with various concentration systems, as further described below.

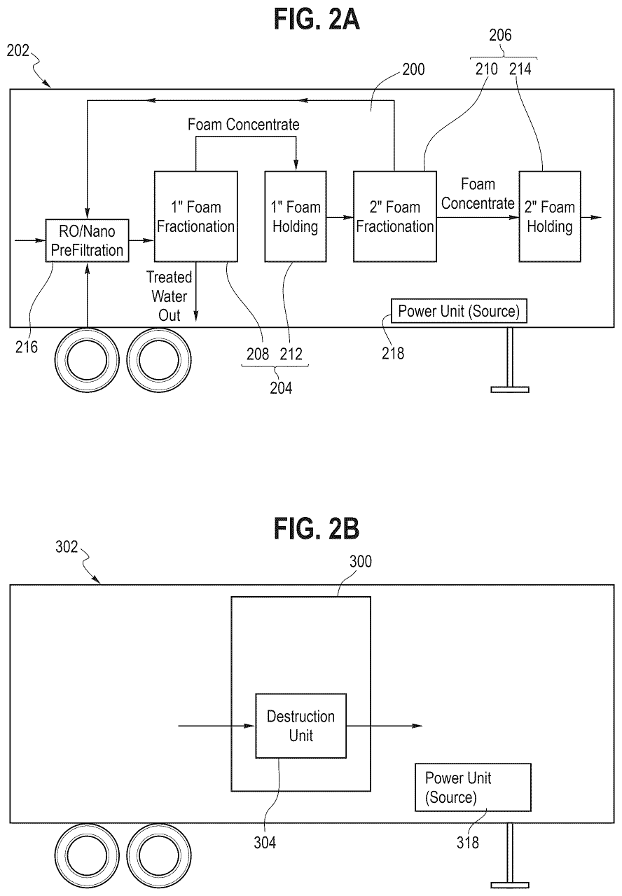

FIG. 2A shows a mobile PFAS concentration system 200 and FIG. 2B shows a mobile PFAS destruction system 300. As shown in FIGS. 2A and 2B of the present disclosure, each of the mobile PFAS concentration system 200 and destruction system 300 employs a separate mobile platform such as a first mobile trailer 202 having the PFAS concentration system 200 and a second mobile trailer 302 having the PFAS destruction system 300. In another approach, the PFAS treatment system may employ a single mobile trailer having both the PFAS concentration system 200 and destruction system 300. However, it is generally feasible to employ separate mobile trailers having each of the PFAS concentration system 200 and the PFAS destruction system 300 due to the size restrictions of the trailer bed that it would be mounted on. Therefore, as shown in FIGS. 2A and 2B, the present disclosure shows the mobile PFAS treatment system 100 that employs at least two separate mobile trailers 202 and 302 for the PFAS concentration system 200 and destruction system 300, respectively.

The mobile systems 200 and 300 may be highly customized and available for rapid response upon arrival without extensive site preparation when water quality deviates from a target level. Further, the mobile trailers 202 and 302 having the respective PFAS concentration and destruction systems 200 and 300 may be climate controlled for use in a variety of conditions, even those involving harsh environments. Each of the mobile PFAS concentration and destruction systems 200 and 300 may be fluidly and directly connectable to source of water for treatment.

FIG. 2A shows the first mobile trailer 202 having the PFAS concentration system 200. In general, the PFAS concentration system 200 has at least one foam concentration unit to perform the task of concentrating the PFAS solution. In an example of FIG. 2A, the PFAS concentration system 200 includes two (2) foam concentration units such as a first concentration unit 204 and a second concentration unit 206. Each of the first and second concentration units 204 and 206 includes a foam fractionation unit and a holding tank. Accordingly, as shown in FIG. 2A, the first concentration unit 204 includes the first foam fractionation unit 208 and the first holding tank 212, and the second concentration unit 206 includes the second foam fractionation unit 210 and the second holding tank 214.

Further, the mobile PFAS concentration system 200 includes at least one nano prefiltration unit 216 (and/or a reverse osmosis system). For purposes of discussion, the nano prefiltration unit 216 will be referenced. The solution from the contaminated site is fed into the at least one nano-prefiltration unit 216 before being let into the first foam fractionation unit 208 of the first concentration unit 204. Each of the first and second foam fractionation units 208 and 210 is aerated to create bubbles or foam. In general, this foam which contains a higher concentration of PFAS than the incoming solution is collected and stored in at least one holding tank.

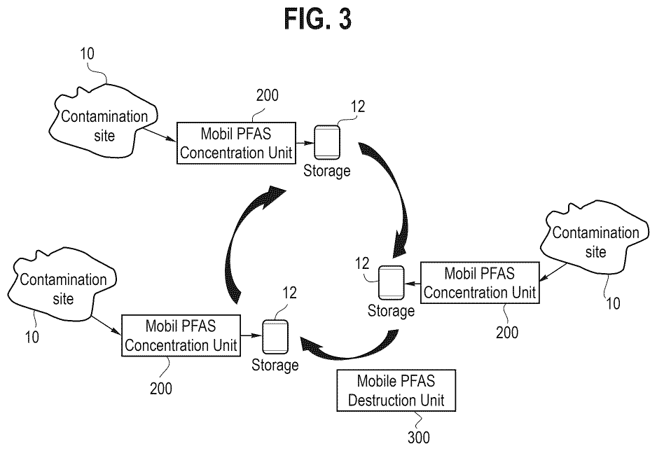

As shown in FIG. 2A, further, the PFAS concentration system 200 has two foam concentration units 204 and 206 such that the solution concentrated from the first concentration unit 204 is fed as needed into the second foam fractionation unit 210 of the second foam concentration unit 206 where the foam is collected again in the second holding tank 214 of the second foam concentration unit 206. The solution is held in in this tank (i.e., the second holding tank 214 in FIG. 2A) until it can be received by the PFAS destruction system 300 (see FIG. 2B). In another approach, each of the contaminated sites 10 includes at least one holding tank 12 additionally stationed for accumulating the PFAS solutions, treated by the PFAS concentration system before treating by the mobile PFAS destruction system 300 (see FIG. 3). Referring back to FIG. 2A, further, power may or may not be available at the treatment site, so a mobile power unit 218 may be provided in the mobile trailer 202 to operate the mobile PFAS concentration system 200.

FIG. 2B shows the second mobile trailer 302 having the PFAS destruction system 300. The PFAS destruction system 300 has at least one PFAS destruction unit 304 for the capability of destroying PFAS solutions, which were stored in the holding tanks 212 and 214 of the mobile PFAS concentration units 204 and 206, and/or additional holding tanks 12 of the contaminated site 10 (see also FIG. 3). As shown in FIG. 2B, the mobile PFAS destruction system 300 installed in the second trailer 302 is also mobile and capable of being stationed at sites where destruction of PFAS solutions is required. In the PFAS destruction system 300, electrochemical oxidation and SCWO have been used to destroy the PFAS solutions at each site as the destruction of PFAS solutions are needed. As shown in FIG. 2B, the at least one PFAS destruction unit 304 may be designed such that they are capable of receiving concentrated PFAS solutions held in the holding tanks (i.e., in fluid communication with the holding tanks). Further, power to run the mobile PFAS destruction unit 304 may come from at least one power source 218 and 318 at the site or be located on the first and/or second mobile trailers 202 and 302. Once the solution is treated, it may be fed back to the beginning of the foam concentration unit for further treatment or placed back into the original contamination source.

As shown in FIGS. 2A and 2B, because the PFAS concentration system 200 and the PFAS destruction system 300 are separate, it is not necessary for both systems to act as a pair (i.e., each system 200 and 300 can be separately and independently operated). For example, the PFAS concentration system 200 can generate a PFAS solution that is held in the at least one holding tanks while the destruction system 300 is not present. The PFAS destruction system 300 is capable of moving to the location where the PFAS concentration system 200 has the accumulated PFAS solution in the holding tanks. Accordingly, the mobile PFAS destruction system 300 is capable of moving from one of the PFAS concentration units (or sites) to the other PFAS concentration units (or sites) for destroying the PFAS solutions stored in the holding tanks at the concentration units (or sites). Due to the separate mobile system, a single mobile PFAS destruction system can serve one or more the PFAS concentration systems for destroying the PFAS solutions. This can reduce costs when multiple contaminated sites require the PFAS treatment.

FIG. 3 is a diagram showing how a single mobile PFAS destruction system 300 can be used to treat at least one PFAS contamination site. As shown in an example of FIG. 3, each of three (3) contamination sites 10 has the respective mobile PFAS concentration system 200 treating the PFAS in each site and also additional holding tanks 12 to hold the accumulated PFAS solutions before destroying the PFAS by the mobile PFAS destruction system 300. The mobile PFAS destruction system 300 moves to each contamination site 10 to destroy the accumulated PFAS solutions stored in the holding tanks. The holding tanks may be the first and second holding tanks 212 and 214 included in the mobile PFAS concentration units 204 and 206 (see FIG. 2A) and/or the third holding tanks 12 stationed in each contaminated site 10 (see FIG. 3).

As shown in FIG. 3, as the mobile PFAS destruction system 300 is capable of moving to each site, the mobile PFAS concentration system 200 may be also capable of traveling from site to site for treating the PFAS of the contamination sites. Thus, one or more concentration systems may be stationed at PFAS contamination sites for concentrating PFAS and storing the PFAS solutions in one of the holding tanks. The overall arrangement also may have as many or fewer mobile PFAS destruction systems that would travel from site to site destroying the concentrated PFAS held in the holding tanks. Accordingly, each of the PFAS concentration system 200 and the PFAS destruction system 300 is designed for mobile application via transportation to each site. Further, the mobile systems 200 and 300 may be used for emergency or temporary applications, such as in areas of low loading requirement where temporary structures are adequate. Further, a single mobile destruction system is able to service one or more concentration units or sites such that the mobile system can reduce costs when multiple sites require the PFAS treatment. Due to the mobile destruction system 300, further, material containing PFAS need not be transported such that the system can avoid the regulatory burden associated with the transportation. In short, the PFAS may remain near the contamination site for treatment and destruction without needing to be transported, and the concentration and/or destruction units may be provided on demand to contamination sites as necessary.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of treating water containing a per- and poly-fluoroalkyl substances (PFAS), the method comprising the steps of:
receiving water containing the PFAS in a PFAS concentration system;
generating a PFAS solution by the PFAS concentration system;
storing the PFAS solution in at least one holding tank;
arranging a mobile PFAS destruction system on a mobile platform; and
selectively connecting the mobile PFAS destruction system to the at least one holding tank and destroying the PFAS solution.

2. The method of claim 1, wherein the step of selectively connecting the mobile PFAS destruction system includes the step of selectively stationing the destruction system at multiple sites having the at least one holding tank to destroy the PFAS solution at each of the multiple sites.

3. The method of claim 1, wherein the step of selectively connecting the mobile PFAS destruction system includes the step of connecting at least one PFAS destruction unit of the mobile PFAS destruction system to the at least one holding tank in a fluid communication.

4. The method of claim 3, wherein the PFAS destruction unit is connected to and in fluid communication with the PFAS concentration system such that a treated PFAS solution is fed back to the PFAS concentration system for further treatment.

5. The method of claim 3, wherein the mobile PFAS destruction system includes a power source configured to operate the PFAS destruction unit.

6. The method of claim 1, wherein the step of receiving the water containing the PFAS includes the step of feeding the water into a nano-prefiltration unit in the PFAS concentration system.

7. The method of claim 1, wherein the PFAS concentration system is arranged on a mobile platform.

8. The method of claim 7, wherein the PFAS concentration system includes at least one PFAS concentration unit having a foam fractionation unit.

9. The method of claim 8, wherein the step of generating the PFAS solution includes the step of creating bubbles or foam by the foam fractionation unit of the at least one PFAS concentration unit.

10. The method of claim 1, wherein the at least one holding tank is placed in a contaminated site or in the PFAS concentration system such that the at least one holding tank is connected to and in fluid communication with a foam fractionation unit of the PFAS concentration system to accumulate the PFAS solution.

11. A system for treating water containing per- and poly-fluoroalkyl substances (PFAS), the system comprising:
a PFAS concentration system including at least one foam concentration unit to generate a PFAS solution;
at least one holding tank storing the PFAS solution; and
a PFAS destruction system arranged on a mobile platform,
wherein the mobile PFAS destruction system is selectively connected to the at least one holding tank to destroy the PFAS solution.

12. The system of claim 11, wherein the mobile PFAS destruction system includes a PFAS destruction unit connected to and in fluid communication with the at least one holding tank.

13. The system of claim 11, wherein the mobile PFAS destruction system is configured to be mobile and selectively stationed at multiple sites having at least one holding tank to destroy the PFAS solution from the at least one holding tank at each of the multiple sites.

14. The system of claim 12, wherein the PFAS destruction unit is connected to and in fluid communication with the PFAS concentration system such that a treated PFAS solution is fed back to the PFAS concentration system for further treatment.

15. The system of claim 12, wherein the mobile PFAS destruction system includes a power source configured to operate the PFAS destruction unit.

16. The system of claim 11, wherein the PFAS concentration system includes a nano-prefiltration unit to receive the water containing the PFAS.

17. The system of claim 11, wherein the PFAS concentration system is arranged on a mobile platform.

18. The system of claim 17, wherein the mobile PFAS concentration system includes the at least one concentration unit having a foam fractionation unit to create bubbles or foam.

19. The system of claim 11, wherein the at least one holding tank is placed in a contaminated site or the PFAS concentration system to store the PFAS solution.
